(19) United States
(12) Patent Application Publication
(10) Pub. No.: US 2026/0030445 A1
(43) Pub. Date: Jan. 29, 2026

(54) REAL-TIME EDITORIAL GUIDELINE COMPLIANCE TOOL

(71) Applicant: Originality.AI Inc., Collingwood (CA)

(72) Inventors: Jonathan GILLHAM, Collingwood (CA); Conor WATT, Collingwood (CA); Liam MCNALLY, Collingwood (CA)

(21) Appl. No.: 18/919,588

(22) Filed: Oct. 18, 2024

Related U.S. Application Data
(60) Provisional application No. 63/674,532, filed on Jul. 23, 2024.

(51) Int. Cl. G06F 40/20

(52) U.S. Cl. CPC G06F 40/20

(57) ABSTRACT

A real-time editorial guideline compliance tool is provided. The real-time editorial guideline compliance tool comprises a server to acquire textual content from a user through a computing device, segment the acquired textual content into multiple textual segments, and analyse each extracted textual segment based on a predefined editorial compliance dataset to determine content compliance status. The predefined editorial compliance dataset comprises approved editorial guidelines for textual content writing. The server generates real-time feedback based on the determined compliance status and renders the generated real-time feedback at the computing device, thereby enabling the user to adhere to the approved editorial guidelines.

### CROSS REFERENCE TO RELATED APPLICATION

This application claims the benefit under 35 U.S.C. § 119 (e) of U.S. Provisional Application No. 63/674,532 entitled “REAL-TIME EDITORIAL GUIDELINE COMPLIANCE TOOL” filed Jul. 23, 2024, which is incorporated herein by reference.

### TECHNICAL FIELD

The present disclosure generally relates to compliance tools. Further, the present disclosure particularly relates to a real-time editorial guideline compliance tool.

### BACKGROUND

The editorial industry has seen significant improvements over the years. Traditional methods of providing adherence to editorial guidelines involved manual proofreading and editing, which were time-consuming and often prone to errors. With the advent of digital technique, various automated tools have been introduced to assist in maintaining editorial standards. Despite said improvements, providing real-time compliance with editorial guidelines remains challenging.

One commonly known system involves using text editing software equipped with basic grammar and spell-checking features. While text editing software can detect and correct basic errors, text editing software lacks the capability to provide adherence to specific editorial guidelines. Moreover, said text editing software often provides feedback only after the entire text has been written, which can lead to significant rework and inefficiency.

Another well-known technique comprises the use of content management systems (CMS) which incorporate editorial guidelines into the workflow. Although CMS can manage large volumes of content and provide some level of guideline enforcement, CMS still relies heavily on manual review processes. Said reliance can result in inconsistencies and delays in content publication.

Additionally, some improved systems employ natural language processing (NLP) algorithms to analyze textual content for compliance with editorial guidelines. Said systems can offer analysis compared to basic text editors and CMS. However, the accuracy of NLP algorithms can be compromised due to variations in writing styles and context-specific nuances. Furthermore, said systems may not provide real-time feedback, thereby hindering the efficiency of content creation.

Other techniques involve the integration of machine learning models to predict and enforce editorial compliance. While machine learning can improve the accuracy of guideline enforcement over time, the initial training phase requires a substantial amount of data and computational resources. Additionally, machine learning models can exhibit biases based on the training data, leading to inaccuracies in guideline compliance.

Furthermore, existing solutions often fail to offer a seamless user experience. Users may need to switch between different tools or platforms to check compliance and make corrections. Said fragmented workflow can reduce productivity and increase the likelihood of errors.

In light of the above discussion, there exists an urgent need for solutions which overcome the problems associated with conventional systems and/or techniques for providing real-time editorial guideline compliance.

### SUMMARY

The objective of the present disclosure is to provide a real-time editorial guideline compliance tool which provides adherence to approved editorial guidelines for textual content writing. The system of the present disclosure aims to enable users to produce high-quality, compliant content efficiently.

In an aspect, the present disclosure provides a real-time editorial guideline compliance tool comprising a server to acquire textual content from a user through a computing device. The server segments the acquired textual content into multiple textual segments and analyses each segment based on a predefined editorial compliance dataset to determine content compliance status. The predefined editorial compliance dataset comprises approved editorial guidelines for textual content writing. The server generates real-time feedback based on the determined compliance status and renders the generated real-time feedback at the computing device, thereby enabling the user to adhere to the approved editorial guidelines.

Furthermore, the system enables improved editorial compliance by providing real-time feedback, reducing manual review efforts, and providing consistency in adherence to editorial guidelines. Additionally, the system improves the quality of textual content by offering detailed analysis and recommendations for compliance.

The server analyses the acquired textual content to generate a report offering insights into a quality compliance score and a consistency compliance score. Said feature enables users to understand and improve user's adherence to editorial guidelines.

The server utilizes a natural language processing (NLP) technique for the assessment of the textual content, evaluating aspects for example emotional tone, grammatical errors, textual coherence, textual consistency, spelling consistency, vocabulary use, sentence structure, punctuation, style and voice tone, context relevance, plagiarism check, clarity and conciseness, and audience appropriateness. Said evaluation provides the content meets standards of quality and compliance.

The server integrates with writing platforms to facilitate improved editorial guideline compliance capabilities directly within the writing platforms where the textual content is created. Said integration assures seamless workflow and improves user productivity.

The server incorporates a machine learning technique for continuous learning and improvement, enabling adaptation to evolving writing styles and user preferences. Said adaptability makes sure the tool remains effective over time.

The server adapts to multiple contexts within the acquired textual content, applying user-specific, organization-specific, or content category-specific editorial guidelines. Said contextual adaptation provides relevant and accurate compliance checks.

The server analyses the readability and accessibility of the acquired textual content, providing recommendations related to language simplicity, use of inclusive language, and adherence to standards.

The server acquires textual content in multiple formats, comprising document files, web content, email bodies and attachments, chat and message logs, database entries, social media posts and comments, content received through API endpoints, transcriptions from speech-to-text conversions, and markdown files.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein.

Embodiments of the present disclosure will now be described, by way of example only, with reference to the following diagrams.

FIG. 1 illustrates a real-time editorial guideline compliance tool 100, in accordance with various implementations of the present disclosure;

FIG. 2 illustrates a sequence diagram for real-time editorial guideline compliance tool, in accordance with the embodiments of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

Numerous specific details are set forth in order to provide a thorough understanding of one or more embodiments of the described subject matter. It is to be appreciated, however, that such embodiments can be practiced without these specific details.

As used herein, the term “real-time editorial guideline compliance tool” refers to a system structured to provide textual content (e.g., news article, tabloid article, blog, short articles interviews, news stories, lengthy articles, statistical information etc.), which adheres to predefined editorial guidelines during the writing process. Said real-time editorial guideline compliance tool comprises various components which work together to analyze and provide feedback on the content. The real-time editorial guideline compliance tool improves the quality and consistency of written content (generated by author, journalist, researchers, academician, scholar etc.) by providing real-time feedback based on editorial standards. The real-time editorial guideline compliance tool can process various formats of textual content, offering insights and recommendations to improve adherence to guidelines.

As used herein, the term “server” refers to a computing unit to perform specific tasks related to processing and analyzing textual content. The server acquires content, segments content, analyzes content against a predefined dataset, and generates feedback. The server can process multiple content formats and provide real-time feedback to users.

As used herein, the term “computing device” refers to any electronic device used by a user to submit textual content and receive feedback. Said computing device comprises devices like computers, tablets, and smartphones. The computing device facilitates the interaction between the user and the server. The computing device allows seamless submission of content and reception of real-time feedback.

As used herein, the term “quality compliance score” refers to a numerical score representing the adherence of textual content to predefined quality standards. Said quality compliance score is based on factors like grammar, coherence, and style. The quality compliance score is generated by analyzing the content against the editorial guidelines. The quality compliance score provides an overall measure of the content quality, helping the user to understand areas for improvement.

As used herein, the term “consistency compliance score” refers to a numerical value representing the uniformity and consistency of textual content. Said consistency compliance score is function of factors like spelling, punctuation, and style consistency. The consistency compliance score is derived from analyzing the content for adherence to editorial guidelines.

As used herein, the term “natural language processing technique” or “NLP technique” refers to computational methods used to analyze and understand human language. The NLP techniques are applied to evaluate textual content for various compliance factors like grammatical accuracy and emotional tone. The NLP techniques are used to process large volumes of text efficiently, providing detailed feedback on multiple aspects of the content.

As used herein, the term “writing platforms” refers to software or online tools used for creating and editing textual content. Writing platforms facilitate the content creation process by providing various features and functionalities. Writing platforms integrate with the server to provide real-time feedback on editorial compliance.

As used herein, the term “machine learning technique” refers to computational methods which enable the server to learn and improve over time. Machine learning techniques are used to improve the analysis and feedback provided on textual content. Machine learning techniques are applied to continuously adapt to evolving writing styles and user preferences. Improving the learning capabilities of the server which helps in providing more accurate and relevant feedback.

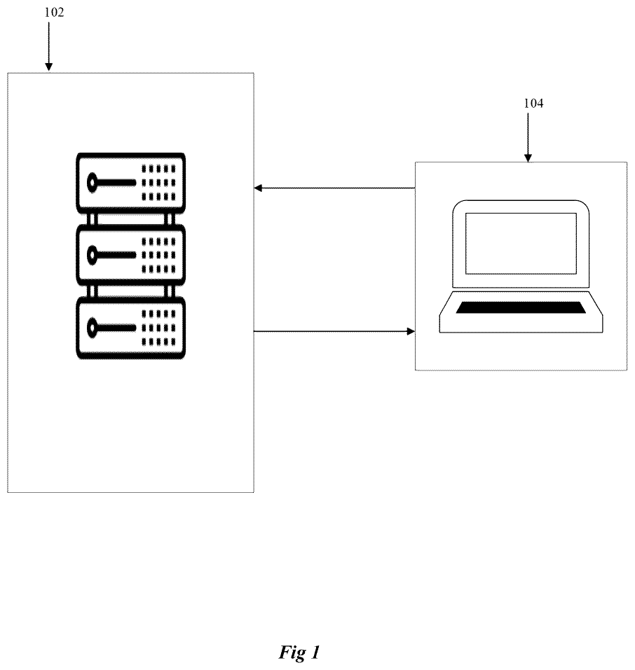

FIG. 1 illustrates a real-time editorial guideline compliance tool 100, in accordance with various implementations of the present disclosure. The real-time editorial guideline compliance tool 100 (interchangeably referred to as tool 100) comprises a server 102 to acquire textual content from a user through a computing device 104. The server 102 initiates the process by receiving textual contents, which may exist in various forms selected from the documents, web a content, the emails, and the other written materials. The server 102 functions as a central processing unit, which handles the intake and preliminary processing of the content.

In an embodiment, server 102 segments the acquired textual content into multiple textual segments. Said segmentation process involves dividing the textual content into manageable parts, allowing for a more detailed and focused analysis of each segment. By breaking down the content, server 102 enables an examination of different sections of the text.

In an embodiment, server 102 analyses each extracted textual segment based on a predefined editorial compliance dataset to determine a content compliance status. The predefined editorial compliance dataset comprises approved editorial guidelines for textual content writing. The server 102 employs various techniques to compare each segment against approved editorial guidelines, evaluating factors for example grammar, style, coherence, and consistency. Said analysis determines whether the content adheres to the established standards or requires modifications.

In an embodiment, server 102 generates real-time feedback based on the determined compliance status. Said real-time feedback is formulated to provide the user with actionable insights to improve the content adherence to the approved editorial guidelines. The feedback comprises suggestions for corrections, improvements, and adherence approaches. By providing real-time feedback, server 102 facilitates immediate adjustments, allowing the user to refine the content efficiently.

In an embodiment, the server 102 renders the generated real-time feedback at the computing device 104, enabling the user to adhere to the approved editorial guidelines. The generated real-time feedback is displayed on the user device, providing clear and concise instructions for content improvement. Said rendering process provides the user which has immediate access to the necessary guidance for refining the content. Rendering real-time feedback on computing device 104 comprises increased user engagement, improved adherence to editorial standards, and a streamlined content creation process.

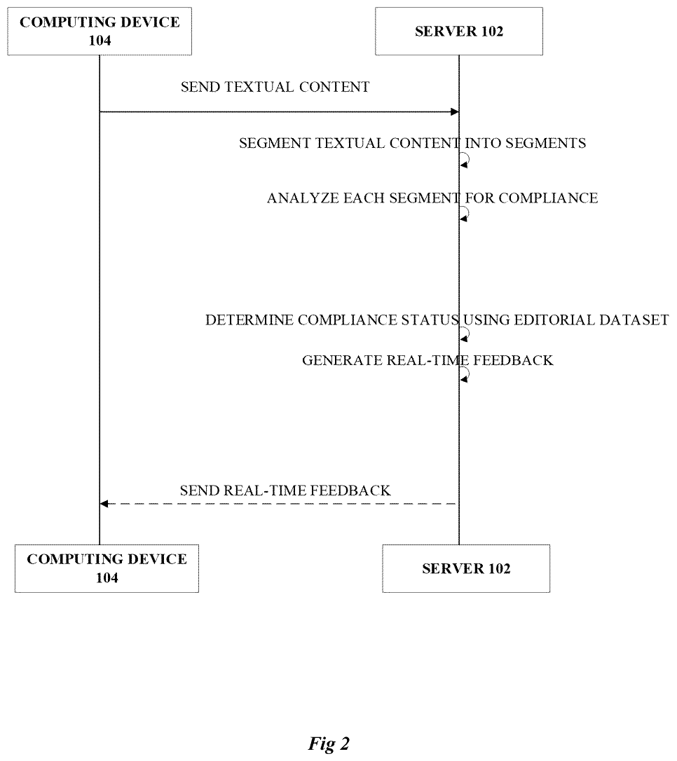

FIG. 2 illustrates a sequence diagram for real-time editorial guideline compliance tool, in accordance with the embodiments of the present disclosure. Computing device 104 sends textual content to server 102. The server 102 segments the textual content into segments. The server 102 then analyzes each segment for compliance. The server 102 determines the compliance status of each segment using an editorial dataset. Following the determination of compliance status, server 102 generates real-time feedback. The server 102 sends the real-time feedback back to the computing device 104. The process involves continuous communication between the computing device 104 and the server 102, enabling effective and prompt evaluation of the textual content for adherence to specified guidelines. The segmentation of the textual content and subsequent analysis by server 102 facilitates accurate and efficient compliance checking, providing immediate feedback to the computing device 104.

In an embodiment, server 102 may analyze the acquired textual content to generate a report offering an insight into a quality compliance score and a consistency compliance score. The server 102 assesses various aspects of the textual content, comprising grammatical accuracy, coherence, and adherence to editorial guidelines. The analysis performed by server 102 involves evaluating the content against predefined criteria to determine the content overall quality and consistency. The resulting report provides the user with a detailed breakdown of the content strengths and areas for improvement. The report comprises improved visibility into the quality of content, enabling the user to make informed decisions on revisions and improvements. The quality compliance score and consistency compliance score offer quantifiable metrics which help the user gauge the effectiveness of the content, providing a higher standard of writing.

In an embodiment, server 102 may utilize a natural language processing (NLP) technique for the assessment of the textual content. The NLP technique is employed to evaluate various elements of the content, comprising emotional tone, grammatical errors, textual coherence, textual consistency, spelling consistency, vocabulary use, sentence structure, punctuation, style, voice tone, context relevance, plagiarism check, clarity and conciseness, and audience appropriateness. The server 102 processes the content through NLP algorithms to identify and analyze said elements, providing an assessment of the quality of the content.

In an embodiment, server 102 may integrate with writing platforms to facilitate improved editorial guideline compliance capabilities directly within the platforms where the textual content is created. The server 102 connects with various writing software and online platforms, enabling seamless interaction and real-time feedback during the writing process. Said integration allows the user to receive immediate guidance and suggestions on editorial compliance without leaving the writing environment.

In an embodiment, server 102 may incorporate a machine learning technique for continuous learning and improvement. Said machine learning technique allows the server 102 to adapt to the evolving writing styles and preferences of the user. The server 102 continuously analyzes the patterns and trends in the writing of the user, updating user editorial compliance dataset to reflect writing style and preferences of the user changes. Said continuous learning process enables the server 102 to provide increasingly accurate and personalized feedback over time.

In an embodiment, server 102 can adapt to multiple contexts within the acquired textual content. The server 102 applies user-specific editorial guidelines, such as preferred writing style, tone consistency, and specific terminology usage. The server 102 also applies organization-specific editorial guidelines, such as adherence to brand voice, compliance with corporate communication policies, and alignment with marketing objectives. Additionally, server 102 applies content category-specific editorial guidelines, such as formatting standards for technical documentation, citation requirements for academic content, and readability metrics for consumer articles. Said adaptability allows the server 102 to tailor analysis and feedback to the specific context of the content, providing content which meets the relevant standards and expectations. The server 102 evaluates the context of the content and selects the appropriate set of guidelines to apply, providing targeted feedback to improve the relevance and effectiveness of the content.

In an embodiment, server 102 may analyze the readability and accessibility of the acquired textual content. The server 102 evaluates various factors such as language simplicity, use of inclusive language, and adherence to established standards. Based on said analysis, server 102 provides one or more recommendations to improve the readability and accessibility of the content. Said recommendations help the user to create content, which is easier to read and understand, and more inclusive for a diverse audience. Analyzing readability and accessibility comprises improved user engagement and comprehension, leading to more effective communication.

In an embodiment, server 102 may acquire textual content in multiple formats. Said formats comprise document files, web content, email bodies and attachments, chat and message logs, database entries, social media posts and comments, content received through API endpoints, transcriptions from speech-to-text conversions, and markdown files. The server 102 is structured to handle said diverse range of content types, providing analysis and feedback regardless of the format. Said capability allows the server 102 to support various content creation and communication platforms, providing consistent editorial compliance across different media.

In an embodiment, the server 102 acquires textual content from the user through the computing device 104, providing a centralized system for receiving and processing data, which facilitates seamless communication between the user device and the server 102. Said acquisition process streamlines the workflow by directly capturing the user input, reducing the likelihood of data loss or corruption during transmission. Moreover, server 102 handles large volumes of incoming textual content which provides efficient processing and storage, thereby supporting scalability and performance even under heavy usage. By centralizing content acquisition, server 102 improves the reliability and accuracy of the data collected, leading to more accurate analysis and feedback generation.

In an embodiment, the segmentation of the acquired textual content into multiple textual segments allows for a more granular analysis of the textual content. Said segmentation facilitates the identification of specific areas within the text which may require modification or improvement, enabling targeted feedback. Furthermore, dividing the content into smaller segments improves the processing speed and accuracy of the analysis, as each segment can be evaluated independently and more efficiently. Said approach also allows for parallel processing, where multiple segments can be analyzed simultaneously, significantly reducing the overall time required to assess the entire content.

In an embodiment, analyzing each extracted textual segment based on a predefined editorial compliance dataset to determine a content compliance status provides each segment of the text adheres to the approved editorial guidelines. Said analysis helps in maintaining consistency and adherence to the established standards, improving the overall quality of the textual content. By focusing on individual segments, the tool 100 can provide more detailed and specific feedback, allowing users to address compliance issues with greater accuracy. Additionally, analyzing each extracted textual segment approach supports continuous improvement by enabling iterative refinement of the content, where users can repeatedly analyze and adjust the text until text meets the desired compliance standards. The detailed analysis contributes to producing high-quality, compliant textual content.

In an embodiment, the predefined editorial compliance dataset comprising the approved editorial guidelines for textual content writing provides a standardized reference for evaluating the textual segments. Said dataset provides all content which is assessed against the same criteria, promoting uniformity and fairness in the compliance evaluation process. By using a well-defined set of guidelines, tool 100 can accurately identify deviations and provide relevant feedback to help users to align content with the required standards. Said predefined editorial compliance dataset approach also supports the ongoing updating and refinement of the guidelines, providing that they remain current and applicable to evolving editorial standards.

In an embodiment, generating real-time feedback based on the determined compliance status provides immediate guidance to users, enabling users to make prompt corrections and improvements to users' content. Said real-time interaction improves the user experience by providing timely and actionable insights, reducing the time and effort required to achieve compliance. Immediate feedback supports a more interactive and engaging content creation process, where users can see the impact of changes in real-time and adjust users approach accordingly. Said dynamic feedback loop fosters continuous learning and improvement, helping users develop a better understanding of the editorial guidelines to apply effectively.

In an embodiment, rendering the generated real-time feedback at the computing device 104 allows users to view and act on the feedback directly from computing device 104. Said local rendering capability provides users have immediate access to the feedback without needing to switch between different systems or interfaces, streamlining the content creation workflow. By providing feedback within the same environment where the content is created, users can quickly and conveniently make the necessary adjustments, improving the content productivity and efficiency. Additionally, the direct rendering of feedback supports a more intuitive and user-friendly experience, as users can easily navigate between the content and the feedback, providing a seamless and integrated content creation process.

In an embodiment, server 102 analyses the acquired textual content to generate a report which provides insights into a quality compliance score and a consistency compliance score. Said analysis helps quantify the level of adherence to editorial guidelines, offering a clear and objective measure of content quality. The report enables users to understand specific areas where users content excels or needs improvement, thus facilitating targeted revisions. By providing distinct scores for quality and consistency, tool 100 allows users to address different aspects of content compliance separately, promoting an approach to content improvement.

In an embodiment, the server 102 utilizes a natural language processing (NLP) technique for the assessment of the textual content, enabling the evaluation of various linguistic and stylistic elements such as emotional tone, grammatical errors, textual coherence, textual consistency, spelling consistency, vocabulary use, sentence structure, punctuation, style and voice tone, context relevance, plagiarism check, clarity and conciseness, and audience appropriateness. Said evaluation provides the content adheres to high linguistic standards, improving readability and engagement. The use of NLP techniques allows for nuanced analysis, capable of detecting subtle issues and providing accurate feedback. By addressing multiple aspects of textual quality, the tool 100 helps create well-rounded and polished content which meets diverse editorial requirements.

In an embodiment, server 102 integrates with writing platforms to facilitate improved editorial guideline compliance capabilities directly within the environments where textual content is created. Said integration with writing platforms streamlines the content creation process by allowing users to receive compliance feedback in real-time without needing to switch between different applications. By embedding compliance tools within writing platforms, tool 100 improves user convenience and productivity, enabling seamless content editing and improvement. Said direct integration supports a more intuitive workflow, where users can make necessary adjustments on the go, providing content meets editorial guidelines.

In an embodiment, server 102 incorporates a machine learning technique for continuous learning and improvement, enabling adaptation to the evolving writing styles and preferences of the user. Said approach allows the tool 100 to personalize feedback based on the user unique writing habits, improving the relevance and usefulness of the suggestions provided. By continuously learning from user interactions, server 102 can refine analysis and feedback mechanisms, providing the real-time editorial guideline compliance tool 100 remains effective and responsive to changing user needs. Said dynamic adaptability supports a more user-centric experience, fostering improved writing skills and adherence to evolving editorial standards over time.

In an embodiment, the server 102 adapts to multiple contexts within the acquired textual content, applying user-specific editorial guidelines, organization-specific editorial guidelines, or content category-specific editorial guidelines. Said contextual adaptation provides that the content is evaluated according to the most relevant standards, improving the content appropriateness and effectiveness for the intended audience. By recognizing and applying different sets of guidelines based on context, server 102 provides more accurate and targeted feedback, supporting diverse content creation needs. Said capability helps maintain consistency and quality across various types of content, whether tailored to individual preferences, organizational requirements, or specific content categories.

In an embodiment, server 102 analyzes the readability and accessibility of the acquired textual content to provide recommendations related to language simplicity, the use of inclusive language, and adherence to standards. Said analysis helps to provide content which is easily understandable and accessible to a broad audience, promoting inclusivity and compliance with established guidelines. By focusing on readability and accessibility, tool 100 supports the creation of content which is high quality and user-friendly and inclusive. Said approach improves the overall impact and reach of the content, making the content more effective and engaging for diverse audiences.

In an embodiment, the server 102 acquire textual content in multiple formats, comprising document files, web content, email bodies and attachments, chat and message logs, database entries, social media posts and comments, content received through API endpoints, transcriptions from speech-to-text conversions, and markdown files. Said versatility allows the real-time editorial guideline compliance tool 100 to process and analyze content from a wide range of sources, supporting editorial compliance across various platforms and media. By accommodating multiple formats, server 102 provides users which can receive consistent and accurate feedback regardless of the origin of the content, improving the applicability and utility of tool 100 in diverse content creation scenarios.

Further disclosed is a computer program product comprising a non-transitory computer-readable storage medium storing instructions which, when executed by a processor, cause a system to perform a method to generate real-time editorial guidelines. The method comprises acquiring textual content from a user through a computing device. The server segments the acquired textual content into multiple textual segments and analyses each segment based on a predefined editorial compliance dataset to determine content compliance status. The predefined editorial compliance dataset comprises approved editorial guidelines for textual content writing. The method further generates real-time feedback based on the determined compliance status and renders the generated real-time feedback at the computing device, thereby enabling the user to adhere to the approved editorial guidelines.

Example embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including hardware, software, firmware, and a combination thereof. For example, in one embodiment, each block of the block diagrams and flowchart illustrations, and combinations of blocks in the block diagrams and flowchart illustrations can be implemented by computer program instructions. These computer program instructions may be loaded onto a general-purpose computer, special purpose computer, or other programmable data processing apparatus to produce a machine, such that the instructions which execute on the computer or other programmable data processing apparatus create means for implementing the functions specified in the flowchart block or blocks.

Throughout the present disclosure, the term ‘processing means’ or ‘microprocessor’ or ‘processor’ or ‘processors’ or ‘control unit’ includes, but is not limited to, a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

The term “non-transitory storage device” or “storage” or “memory,” as used herein relates to a random-access memory, read only memory and variants thereof, in which a computer can store data or software for any duration.

Operations in accordance with a variety of aspects of the disclosure is described above would not have to be performed in the precise order described. Rather, various steps can be handled in reverse order or simultaneously or not at all.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

Throughout the present disclosure, the term ‘Artificial intelligence (AI)’ as used herein relates to any mechanism or computationally intelligent system that combines knowledge, techniques, and methodologies for controlling a bot or other element within a computing environment. Furthermore, the artificial intelligence (AI) is configured to apply knowledge and that can adapt it-self and learn to do better in changing environments. Additionally, employing any computationally intelligent technique, the artificial intelligence (AI) is operable to adapt to unknown or changing environment for better performance. The artificial intelligence (AI) includes fuzzy logic engines, decision-making engines, preset targeting accuracy levels, and/or programmatically intelligent software.

What is claimed is:

1. A real-time editorial guideline compliance tool comprising:
a server configured to:
acquire textual content from a user through a computing device;
segment the acquired textual content into multiple textual segments;
analyze each extracted textual segment based on a predefined editorial compliance dataset to determine a content compliance status, wherein the predefined editorial compliance dataset comprises the approved editorial guidelines for textual content writing;
generate real-time feedback based on the determined compliance status; and
render, at the computing device, the generated real-time feedback enabling the user to adhere to the approved editorial guidelines.

2. The real-time editorial guideline compliance tool of claim 1, wherein the server analyses the acquired textual content to generate a report offering an insight into a quality compliance score and a consistency compliance score.

3. The real-time editorial guideline compliance tool of claim 1, wherein the server utilizes a natural language processing (NLP) technique for assessment of the textual content to evaluate an emotional tone, grammatical errors, textual coherence, textual consistency, spelling consistency, vocabulary use, a sentence structure, punctuation, style and voice tone, context relevance, a plagiarism check, clarity and conciseness and audience appropriateness.

4. The real-time editorial guideline compliance tool of claim 1, wherein the server integrates with writing platforms to facilitate one or more improved editorial guideline compliance capabilities directly within the writing platforms where the textual content is created.

5. The real-time editorial guideline compliance tool of claim 1, wherein the server incorporates a machine learning technique for continuous learning and improvement, enabling adaptation to the evolving one or more writing styles and one or more preferences of the user.

6. The real-time editorial guideline compliance tool of claim 1, wherein the server adapts to the multiple contexts within the acquired textual content, applying a user-specific editorial guideline, an organization-specific editorial guideline, or a content category-specific editorial guideline.

7. The real-time editorial guideline compliance tool of claim 1, wherein the server analyzes readability and accessibility of the acquired textual content to provide one or more recommendations related to language simplicity, the use of inclusive language, and an adherence to one or more standards.

8. The real-time editorial guideline compliance tool of claim 1, wherein the server is configured to acquire the textual content in the multiple formats selected from the document files, web content, email bodies and attachments, chat and message logs, database entries, the social media posts and comments, content received through API endpoints, the transcriptions from the speech-to-text conversions, and the markdown files.

9. A method for generating real-time editorial guidelines, the method comprising:
acquiring textual content from a user through a computing device;
segmenting the acquired textual content into one or more textual segments;
analyzing one or more extracted textual segments based on a predefined editorial compliance dataset to determine a content compliance status, wherein the predefined editorial compliance dataset comprises the approved editorial guidelines for textual content writing;
generating real-time feedback based on the determined compliance status; and
rendering the generated real-time feedback on user interface.

10. The method of claim 9, wherein the server analyses the acquired textual content to generate a report for offering an insight for a quality compliance score and a consistency compliance score.

11. The method of claim 9, wherein the server utilizes a natural language processing (NLP) technique for assessment of the textual content to evaluate an emotional tone, grammatical errors, textual coherence, textual consistency, spelling consistency, a vocabulary use, a sentence structure, punctuation, style and voice tone, context relevance, a plagiarism check, clarity and conciseness and audience appropriateness.

12. The method of claim 9, wherein the server integrates with the writing platforms to facilitate one or more improved editorial guideline compliance capabilities directly within the writing platforms where the textual content is created.

13. The method of claim 9, wherein the server incorporates a machine learning technique for continuous learning and improvement, enabling adaptation to the evolving one or more writing styles and one or more preferences of the user.

14. The method of claim 9, wherein the server adapts to the multiple contexts within the acquired textual content, applying a user-specific editorial guideline, an organization-specific editorial guideline, or a content category-specific editorial guideline.

15. The method of claim 9, wherein the server analyzes readability and accessibility of the acquired textual content to provide one or more recommendations related to language simplicity, use of inclusive language, and an adherence to one or more standards.

16. The method of claim 9, wherein the server is configured to acquire the textual content in the multiple formats selected from the document files, web content, email bodies and attachments, chat and message logs, the database entries, the social media posts and comments, content received through API endpoints, the transcriptions from the speech-to-text conversions, and the markdown files.

17. A computer program product comprising a non-transitory computer-readable storage medium storing instructions which, when executed by a processor, cause a system to perform a method to generate real-time editorial guidelines, the method comprising:
acquiring textual content from a user through a computing device;
segmenting the acquired textual content into one or more textual segments;
analyzing one or more extracted textual segments based on a predefined editorial compliance dataset to determine a content compliance status, wherein the predefined editorial compliance dataset comprises the approved editorial guidelines for textual content writing;
generating real-time feedback based on the determined compliance status; and
rendering the generated real-time feedback on user interface.
